(19) United States
(12) Patent Application Publication
(10) Pub. No.: US 2026/0190183 A1
(43) Pub. Date: Jul. 2, 2026

(54) Hand Warmer Unit and Hand Warmer

(71) Applicant: Na Zhou, Dongguan City (CN)

(72) Inventors: Na Zhou, Dongguan City (CN); Yong Zhou, Dongguan City (CN)

(21) Appl. No.: 19/367,949

(22) Filed: Oct. 24, 2025

(30) Foreign Application Priority Data
Dec. 26, 2024 (CN) 202423238632.X

(51) Int. Cl. H05B 3/06

(52) U.S. Cl. CPC H05B 3/06

(57) ABSTRACT

A hand warmer unit and a hand warmer. The hand warmer unit includes a housing and a magnetic component. The housing includes a surrounding wall and a magnetic attraction wall. The surrounding wall and the magnetic attraction wall are connected to each other and enclose to define a cavity. The magnetic component is disposed in the cavity. The magnetic attraction wall includes a thin wall area and a thick wall area that are connected to each other. An inner side of the magnetic attraction wall is thinned to form the thin wall area. The magnetic component is attached to the thin wall area.

### CROSS-REFERENCE TO RELATED APPLICATIONS

The present application is a claims priority of Chinese Patent Application No. 202423238632.X, filed on December 26, 2024, the entire contents of which are hereby incorporated by reference in its entirety.

### TECHNICAL FIELD

The present disclosure relates to the technical field of household heating products, and in particular to a hand warmer unit and a hand warmer.

### BACKGROUND

Typically, a hand warmer unit requires both hands of a user to hold it during use and cannot be separated, which limits its flexibility in application. If separate use is needed, two hand warmer units must be purchased. However, this approach leads to inconveniences in carrying and storage, and does not allow for combined application of the two units. In view of this, the related art employs the magnetic principle, aiming to enable two hand warmer units to be used either independently or in combination. However, due to insufficient magnetic attraction, both combined use and storage of the two hand warmer units are inconvenient.

The above content is intended to assist in understanding the technical solution of the present disclosure and does not constitute an admission that the above content is prior art.

### SUMMARY OF THE DISCLOSURE

The present disclosure proposes a hand warmer unit, including a housing and a magnetic attraction component, and the housing includes a surrounding wall and a magnetic attraction wall; the surrounding wall and the magnetic attraction wall are connected to each other and enclose to define a cavity; the magnetic attraction component is disposed in the cavity; the magnetic attraction wall includes a thin wall area and a thick wall area which are connected to each other; an inner side surface of the magnetic attraction wall is thinned to form the thin wall area; the magnetic attraction component is attached to the thin wall area.

In some embodiments, the thick wall area is arranged around a periphery of the thin wall area, the magnetic attraction wall further includes a connection area connecting the thick wall area and the thin wall area, and a thickness of the connection area gradually decreases from a side close to the thick wall area to a side close to the thin wall area.

In some embodiments, the hand warmer unit further includes a limiting component; the limiting component is arranged along the periphery of the thin wall area and encloses with the thin wall area to define an accommodation space, and the magnetic attraction component is disposed in the accommodation space.

In some embodiments, the limiting component is a limiting ring; an end of the limiting ring is connected to a junction of the connection area and the thin wall area, and another end of the limiting ring extends away from the magnetic attraction wall; an end face of the limiting ring away from the thin wall area is higher than an inner side surface of the thick wall area.

In some embodiments, the magnetic attraction wall is elongated, and the thin wall area is disposed in a middle of the magnetic attraction wall; a length of the thin wall area is one quarter of a length of the magnetic attraction wall, and a width of the thin wall area is one half of a width of the magnetic attraction wall.

In some embodiments, the hand warmer unit further includes two heating assemblies on the surrounding wall, and the two heating assemblies are arranged on opposite sides of the magnetic attraction wall.

In some embodiments, the housing includes two main body shells; the two main body shells are spliced to form the surrounding wall and enclose to define an opening; the magnetic attraction wall is connected to the two main body shells at the opening; the two heating assemblies are arranged on the two main body shells in a one-to-one correspondence.

In some embodiments, the magnetic attraction wall is elongated; the heating assembly extends along a length direction of the magnetic attraction wall, and the two heating assemblies are arranged on both sides of the magnetic attraction wall in a width direction.

In some embodiments, the hand warmer unit further includes a button assembly and a charging assembly disposed on the magnetic attraction wall; the button assembly and the charging assembly are respectively arranged on both sides of the magnetic attraction component.

In some embodiments, the hand warmer unit further includes a heating assembly disposed on the surrounding wall; an outer surface of the housing defines an installation slot, and the heating assembly is disposed in the installation slot; a bottom wall of the installation slot is arranged with an installation position communicating with the cavity; the hand warmer unit further includes a temperature sensing component, and the temperature sensing component is arranged at the installation position.

In some embodiments, the bottom wall of the installation slot further defines a wire passing hole, and the wire passing hole connects the installation position and the cavity.

In some embodiments, a side of the magnetic attraction wall facing the cavity is further arranged with a fixed post and a positioning post; the hand warmer unit further includes a circuit board and a fastener, the circuit board defines a first hole and a second hole to match with the fixed post and the positioning post, respectively; wherein the positioning post is inserted into the first hole, and the fastener passes through the second hole and is fixedly connected to the fixed post.

The present disclosure further proposes a hand warmer, including at least two hand warmer units, wherein each hand warmer unit includes a housing and a magnetic attraction component, and the housing includes a surrounding wall and a magnetic attraction wall; the surrounding wall and the magnetic attraction wall are connected to each other and enclose to define a cavity; the magnetic attraction component is disposed in the cavity. The magnetic attraction wall includes a thin wall area and a thick wall area which are connected to each other; an inner side surface of the magnetic attraction wall is thinned to form the thin wall area; the magnetic attraction component is attached to the thin wall area; wherein the magnetic attraction walls of the two hand warmer units are capable of being aligned for magnetic attraction.

### BRIEF DESCRIPTION OF THE DRAWINGS

To more clearly illustrate the technical solutions in the embodiments of the present disclosure, the drawings used in the description of the embodiments will be briefly introduced below. Obviously, the drawings in the following description are only some embodiments of the present disclosure, and for those skilled in the art, other drawings may be obtained based on these drawings without creative effort.

FIG. 1 is a structural schematic view of a hand warmer unit according to some embodiments of the present disclosure from one perspective.

FIG. 2 is a structural schematic view of a hand warmer unit according to some embodiments of the present disclosure from another perspective.

FIG. 3 is an exploded view of the hand warmer unit in FIG. 2.

FIG. 4 is a top view of the hand warmer unit in FIG. 2.

FIG. 5 is a cross-sectional view of the hand warmer unit in FIG. 4 along line V-V.

FIG. 6 is a partial enlarged view of portion A circumscribed in FIG. 5.

FIG. 7 is a partial structural schematic view of the hand warmer unit in FIG. 2.

FIG. 8 is a structural schematic view of a magnetic attraction wall in FIG. 2.

FIG. 9 is another partial structural schematic view of the hand warmer unit in FIG. 2.

FIG. 10 is a structural schematic view of a hand warmer of the present disclosure.

The realization of the objectives, functional features, and advantages of the present disclosure will be further explained in combination with the embodiments and with reference to the drawings.

### DETAILED DESCRIPTION

Below, the technical solutions in the embodiments of the present disclosure will be clearly and completely described in combination with the drawings in the embodiments of the present disclosure. Obviously, the described embodiments are only a part of the embodiments of the present disclosure, not all of them. Based on the embodiments in the present disclosure, all other embodiments obtained by those skilled in the art without creative effort shall fall within the scope of the present disclosure. In addition, the technical solutions between various embodiments may be combined with each other, but it must be based on the ability of those skilled in the art to realize them. When the combination of technical solutions results in mutual contradiction or cannot be realized, it should be considered that such a combination of technical solutions does not exist and is not within the scope of protection claimed by the present disclosure.

It should be noted that when there are directional indications (such as up, down, left, right, front, back, etc.) in the embodiments of the present disclosure, these directional indications are only intended to explain the relative positional relationships and movements between various components in a specific posture, and if the specific posture changes, the directional indications will change accordingly.

Furthermore, when there are descriptions such as “first” and “second” in the embodiments of the present disclosure, these descriptions are only for descriptive purposes and cannot be understood as indicating or implying relative importance or implicitly indicating the number of technical features referred to. Thus, features defined with “first” and “second” may explicitly or implicitly include at least one such feature. In addition, the meaning of “and/or” appearing in the full text includes three parallel solutions. Taking “A and/or B” as an example, it includes solution A, or solution B, or a solution that satisfies both A and B simultaneously.

The present disclosure proposes a hand warmer unit.

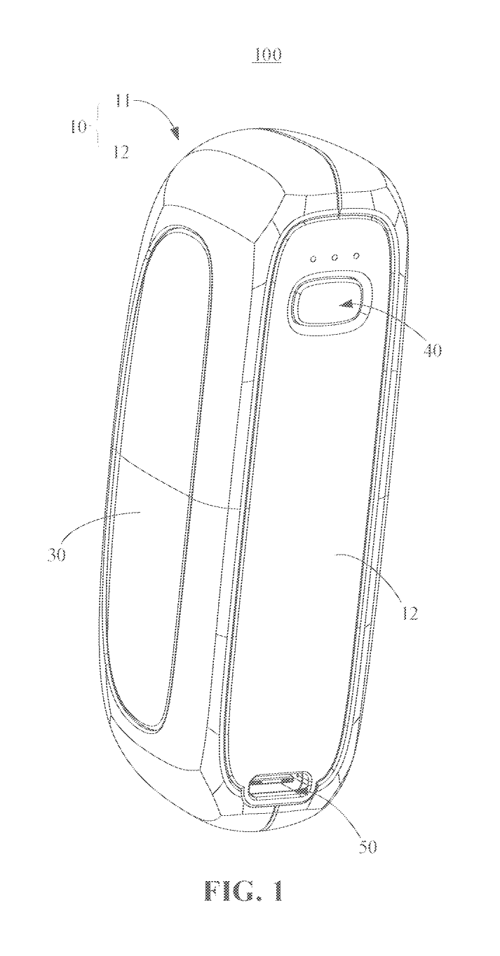

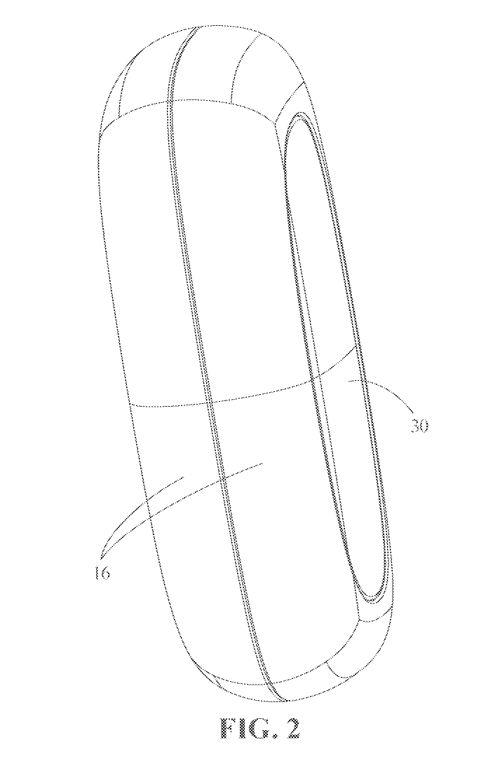

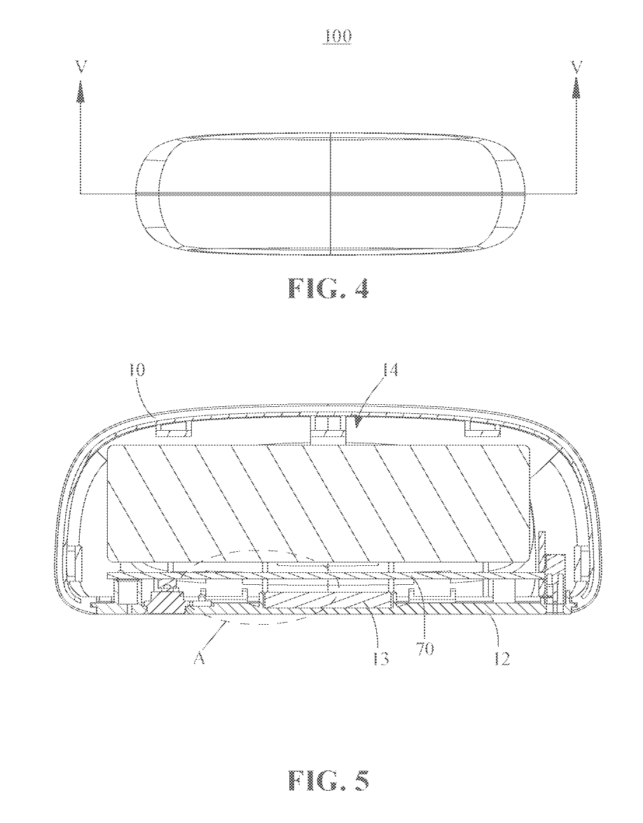

In some embodiments of the present disclosure, referring to FIGS. 1 to 6, the hand warmer unit 100 includes a housing 10 and a magnetic component 13. The housing 10 includes a surrounding wall 11 and a magnetic attraction wall 12. The surrounding wall 11 and the magnetic attraction wall 12 are connected to each other and enclose to define a cavity 14. The magnetic component 13 is disposed in the cavity 14. The magnetic attraction wall 12 includes a thin wall area 121 and a thick wall area 122 that are connected to each other. An inner side of the magnetic attraction wall 12 is thinned to form the thin wall area 121. The magnetic component 13 is attached to the thin wall area 121.

The housing 10 serves to protect internal components and provide structural support. The housing 10 includes the surrounding wall 11, the magnetic attraction wall 12, and the magnetic component 13.

The main function of the surrounding wall 11 is to enclose and define the cavity 14 together with the magnetic attraction wall 12, providing accommodation space for other components inside the hand warmer 200 (such as the magnetic component 13, and possible heating elements, energy storage elements, etc.), playing a role in protecting and fixing internal components, and also defining the external contour of the hand warmer 200, thereby affecting its appearance and handheld convenience.

The magnetic attraction wall 12, on one hand, serves as part of the cavity 14, ensuring the integrity and stability of the hand warmer 200 structure together with the surrounding wall 11. On the other hand, due to its special design of the thin wall area 121 and thick wall area 122 and its coordination with the magnetic component 13, it plays a key role in realizing the magnetic attraction function. The number of magnetic attraction walls 12 may be one or multiple. When the number of magnetic attraction walls 12 is one, two hand warmer units 100 may be combined for use through aligned magnetic attraction of the magnetic attraction walls 12. When the number of magnetic attraction walls 12 is multiple, multiple hand warmer units 100 may be combined for use through aligned magnetic attraction of the magnetic attraction walls 12.

Compared to being arranged in the thick wall area 122, when the magnetic component 13 is arranged in the thin wall area 121, the magnetic permeability and magnetic attraction stability are better. Specifically, because the material thickness of the thin wall area 121 is thinner, the magnetic loss of the magnetic component 13 is relatively small, and the magnetic force of the magnetic component 13 can penetrate the material more directly. Moreover, the gap between the magnetic component 13 and the adsorbed object is smaller, thereby helping to enhance the connection stability. The thin wall area 121 may be circular, rectangular, etc., and there is no restriction on the shape of the thin wall area 121.

The thick wall area 122 can provide better support when bearing external forces, thereby preventing the overall structure from becoming too fragile due to the existence of the thin wall area 121.

The magnetic component 13 being attached to the thin wall area 121 means that the magnetic component 13 is attached or nearly attached to the thin wall area 121, which may reduce the distance between the magnetic component 13 and the thin wall area 121 and reduce the gap between the magnetic component 13 and the adsorbed object, thereby enhancing the connection stability.

In the embodiments, the magnetic component 13 may be a cylinder, cuboid, cube, etc., and there is no restriction on the shape of the magnetic component 13. The number of magnetic components 13 may be one or multiple.

The adsorbed object may be another hand warmer unit 100. In this way, two hand warmer units 100 can be used separately or combined for use or storage through the magnetic attraction function. The adsorbed object may be a metal desktop, etc., which is not limited herein.

The present disclosure provides a hand warmer unit 100, including a housing 10 and a magnetic component 13. The housing 10 includes a surrounding wall 11 and a magnetic attraction wall 12. The surrounding wall 11 and the magnetic attraction wall 12 are connected to each other and enclose to define a cavity 14. The magnetic component 13 is disposed in the cavity 14. The magnetic attraction wall 12 includes a thin wall area 121 and a thick wall area 122 that are connected to each other. An inner side of the magnetic attraction wall 12 is thinned to form the thin wall area 121. The magnetic component 13 is attached to the thin wall area 121. By attaching the magnetic component 13 to the thin wall area 121, the present disclosure enables the magnetic force of the magnetic component 13 to penetrate the material more directly, and the gap between the magnetic component 13 and the adsorbed object is smaller, thereby helping to enhance the magnetic attraction effect and the connection stability.

Further, referring to FIGS. 4 to 6, the thick wall area 122 is arranged around a periphery of the thin wall area 121. The magnetic attraction wall 12 further includes a connection area 123 connecting the thick wall area 122 and the thin wall area 121. A thickness of the connection area 123 gradually decreases from a side close to the thick wall area 122 to a side close to the thin wall area 121.

In the embodiments, the thick wall area 122 arranged around the periphery of the thin wall area 121 provides strong support structure for the thin wall area 121, which may enhance the pressure resistance and deformation resistance of the entire magnetic attraction wall 12 and even the entire housing 10 when facing external forces, thereby ensuring that in daily use, such as when being squeezed or collided, the thin wall area 121 and the magnetic component 13 attached to its inner side will not be damaged by external forces, so as to maintain the normal function and appearance integrity of the hand warmer 200.

The connection area 123 connecting the thick wall area 122 and the thin wall area 121 achieves a smooth transition between the thick wall area 122 and the thin wall area 121. The thickness of the connection area 123 gradually decreases from the side close to the thick wall area 122 to the side close to the thin wall area 121, which may avoid stress concentration between two areas of different thicknesses, effectively disperse the stress generated by thickness changes, prevent problems such as cracks and damage in the magnetic attraction wall 12 due to stress concentration, and improve the overall structural strength and service life of the magnetic attraction wall 12.

In addition, during a glue injection process, the connection area 123 can act as a buffer. If there were no connection area 123 between the thick wall area 122 and the thin wall area 121, the glue might locally accumulate or flow unevenly due to the sudden thickness change when transitioning from the thick wall area 122 to the thin wall area 121. In the embodiments, the thickness of the connection area 123 is gradual, which allows the glue to flow from the thick wall area 122 to the thin wall area 121 in a gentler manner, avoiding adverse phenomena such as glue overflow in the thin wall area 121 due to sudden pressure changes or local glue clumping, thereby ensuring the quality and uniformity of glue injection. In other words, the existence of the connection area 123 may eliminate adverse reactions during glue injection, allowing the magnetic attraction wall 12 to achieve the design of the thin wall area 121 and thick wall area 122, while ensuring the structural strength of the magnetic attraction wall 12 and its aesthetic appearance.

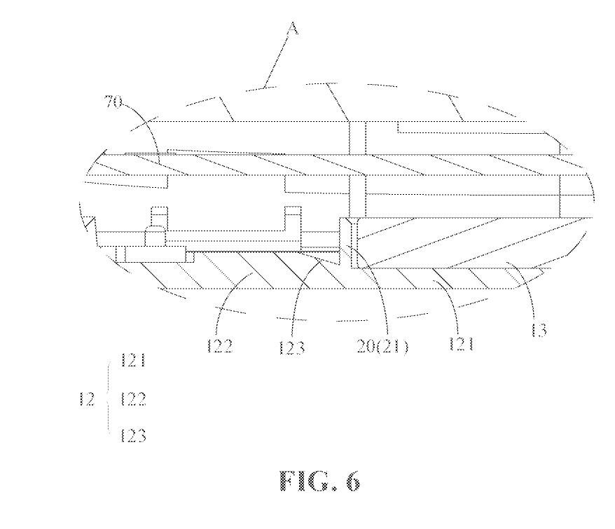

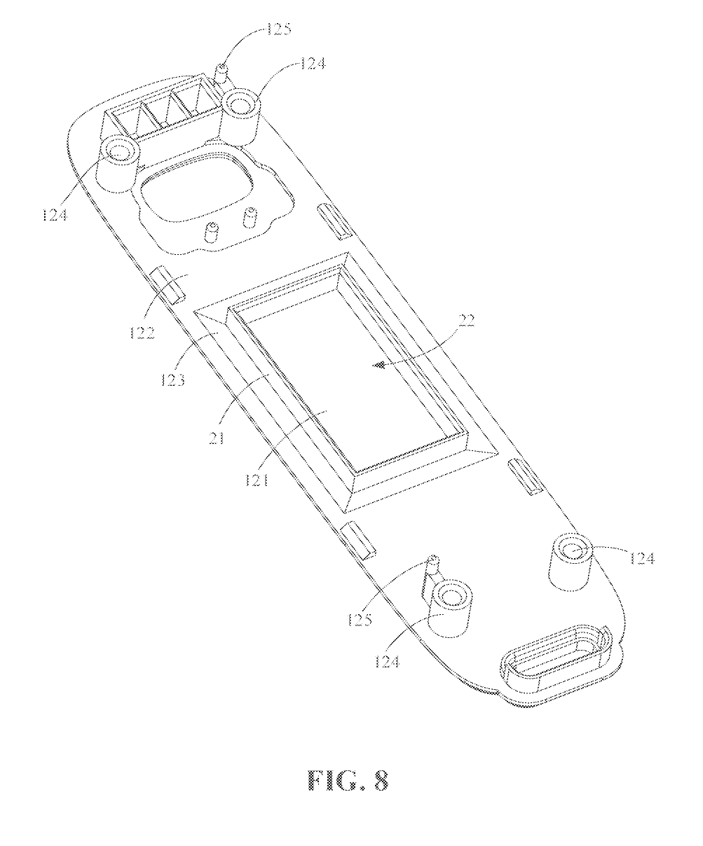

Referring to FIGS. 6 and 8, the hand warmer unit 100 further includes a limiting component 20. The limiting component 20 is arranged along the periphery of the thin wall area 121 and encloses with the thin wall area 121 to define an accommodation space 22. The magnetic component 13 is disposed in the accommodation space 22.

In the embodiments, the limiting component 20 may accurately limit the position of the magnetic component 13, preventing the magnetic component 13 from shifting during the use of the hand warmer 200 (such as daily handling, movement, or even under certain external impact). Furthermore, the magnetic component 13 is stably restricted within the accommodation space 22, ensuring its relative position with the thin wall area 121 is fixed, such that the magnetic field acts outward stably through the thin wall area 121, thereby achieving consistency and stability of the magnetic attraction effect.

The limiting component 20 may be a complete and integrated limiting ring 21, or multiple limiting units arranged at intervals. There is no restriction on the specific form of the limiting component 20.

Further, referring to FIGS. 6 and 8, the limiting component 20 is a limiting ring 21. An end of the limiting ring 21 is connected to a junction of the connection area 123 and the thin wall area 121, and another end of the limiting ring 21 extends away from the magnetic attraction wall 12. An end face of the limiting ring 21 away from the thin wall area 121 is higher than an inner side of the thick wall area 122.

In the embodiments, compared to relying solely on a planar limiting structure, the limiting ring 21, which is annular and has a certain height extension, may more tightly restrict the movement range of the magnetic component 13 and protect the magnetic component 13 from external impact. When the hand warmer 200 is subjected to external impacts from different directions (such as falling, collision, squeezing, etc.), the limiting ring 21 limits the magnetic component 13 from all directions, ensuring that the magnetic component 13 always remains within the accommodation space 22, thereby stably performing its magnetic attraction function. In addition, the limiting ring 21 can first bear and disperse these external forces, avoiding direct action on the magnetic component 13, thereby ensuring the integrity of the magnetic component 13.

In some embodiments, referring to FIG. 8, the magnetic attraction wall 12 is elongated. The thin wall area 121 is disposed in the middle of the magnetic attraction wall 12, a length of the thin wall area 121 is one-quarter of a length of the magnetic attraction wall 12, and a width of the thin wall area 121 is one-half of a length of the magnetic attraction wall 12.

In the embodiments, the elongated magnetic attraction wall 12 conforms to the user’s natural holding habits, thereby facilitating handheld warming, and further allowing easy operation when adsorption fixation is needed.

The arrangement of the thin wall area 121 in the middle of the magnetic attraction wall 12 may make the magnetic attraction force more concentrated and prominent in the central area of the elongated magnetic attraction wall 12. When the hand warmer 200 approaches the adsorbed object, it can form a strong adsorption effect in this key area, which is more conducive to the stable adsorption of the hand warmer 200 on the target object.

The specific size ratio of the thin wall area 121 may ensure the overall structural stability of the magnetic attraction wall 12, thereby reducing problems such as displacement of the magnetic component 13 and damage to internal components due to structural deformation, and further allow the magnetic field generated by the magnetic component 13 to act more effectively on external objects, thereby effectively enhancing the magnetic attraction effect.

In some embodiments, there may be multiple thin wall areas 121 on the magnetic attraction wall 12. For example, thin wall areas 121 may be provided on both sides of the magnetic attraction wall 12 in the length direction.

In some embodiments, referring to FIGS. 1 to 3, the hand warmer unit 100 further includes two heating assemblies 30 on the surrounding wall 11. The two heating assemblies 30 are arranged on opposite sides of the magnetic attraction wall 12.

In the embodiments, the heating assembly 30 includes but is not limited to a heating element, a heat conduction element, and an insulation pad. Compared to setting only one heating assembly 30, the two heating assemblies 30 in the embodiments may generate more heat in the same time, thereby accelerating the overall heating speed of the hand warmer 200 and improving its warming efficiency.

If the heating assembly 30 were arranged on the magnetic attraction wall 12, the heat generated during operation might cause deformation in different areas of the magnetic attraction wall 12 (thin wall area 121 and thick wall area 122) due to different degrees of thermal expansion and contraction, thereby changing the attachment state between the magnetic component 13 and the magnetic attraction wall 12 and reducing magnetic performance. In the embodiments, the arrangement of the heating assembly 30 on the surrounding wall 11 may avoid adverse effects on the magnetic attraction wall 12 and make full use of the surrounding wall 11, thereby making the overall structure of the hand warmer unit 100 more compact.

The two heating assemblies 30 are respectively arranged on opposite sides of the magnetic attraction wall 12, which may help to transfer heat more evenly, ensuring that the magnetic component 13 has uniform magnetic force distribution when heated, thereby enhancing overall adsorption stability. In addition, this design may further ensure a good warming experience under different holding states.

For example, when holding with one hand, when the palm faces the magnetic attraction wall 12, the fingers contact the heating assembly 30 to obtain heat; when the palm faces the heating assembly 30, not only can the palm directly feel the heat, but the fingers can also obtain heat simultaneously. When holding with both hands, the two heating assemblies 30 can provide heat to both hands simultaneously. The user’s hands respectively contact both sides of the hand warmer 200, and each hand can directly obtain warmth from the corresponding heating assembly 30, with even heat distribution. This even heat supply allows all parts of the hands, such as the palms and fingers, to be fully warmed, thereby avoiding the possible heat imbalance when warming with one hand.

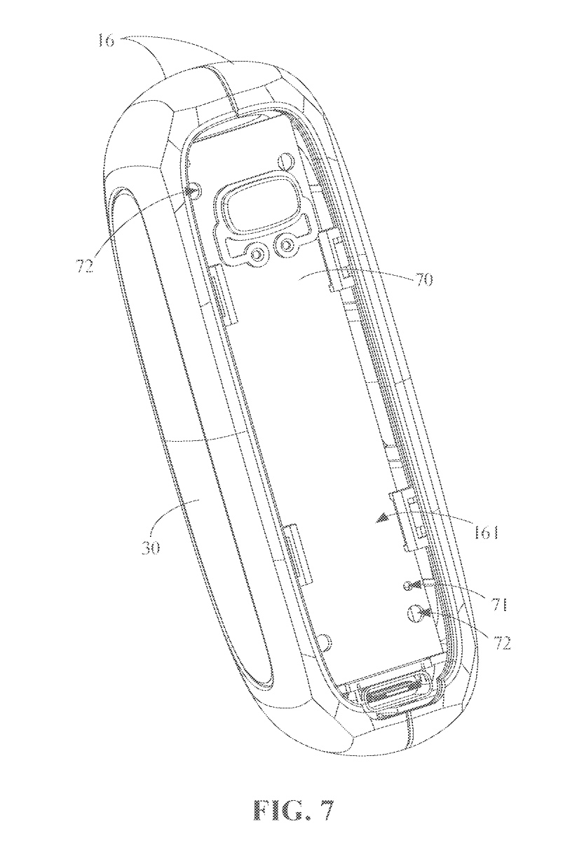

In some embodiments, referring to FIG. 7, the housing 10 includes two main body shells 16. The two main body shells 16 are spliced to form the surrounding wall 11 and enclose to define an opening 161. The magnetic attraction wall 12 is connected to the main body shells 16 at the opening 161. The two heating assemblies 30 are respectively arranged on the two main body shells 16.

Compared to a complex integrally formed housing structure, the two main body shells 16 in the embodiments may be processed and manufactured separately, for example, separately formed by injection molding, stamping, etc., and then spliced and assembled. This production method may improve production efficiency and reduce production difficulty. During assembly, if one main body shell 16 has quality problems, it is easy to replace separately without causing the entire housing 10 to be scrapped, thereby reducing production costs.

In some embodiments, referring to FIGS. 1 to 3, the magnetic attraction wall 12 is elongated, the heating assembly 30 extends along the length direction of the magnetic attraction wall 12, and the two heating assemblies 30 are respectively arranged on both sides of the magnetic attraction wall 12 in the width direction.

In the embodiments, the elongated magnetic attraction wall 12 has a certain length range, and this extension setting of the heating assembly 30 can cover a longer distance, allowing heat to fully diffuse throughout the housing 10, thereby avoiding local heat concentration or uneven cold and heat. In addition, this elongated magnetic attraction wall 12 and such a layout of the heating assembly 30 conform to the natural holding and contact means of the human hand. When the user holds the hand warmer 200, the hand holds along the elongated hand warmer 200, and no matter from which direction it is held, heat from both heating assemblies 30 can be felt, fitting the physiological curve and heat sensation habits of the hand, thereby improving the convenience and comfort of product use and meeting the user’s warming needs in different holding postures.

In some embodiments, referring to FIGS. 1, 3, and 8, the hand warmer unit 100 further includes a button assembly 40 and a charging assembly 50 disposed on the magnetic attraction wall 12. The button assembly 40 and the charging assembly 50 are respectively arranged on both sides of the magnetic component 13.

If the button assembly 40, charging assembly 50, and heating assembly 30 were all disposed on the surrounding wall 11, the user would often instinctively hold the position where the heating assembly 30 is located for quick warming during use. This may easily lead to accidental touching of the button assembly 40 or discomfort due to the charging assembly 50. In the embodiments, the button assembly 40 and charging assembly 50 are disposed on both sides of the magnetic attraction wall 12. For the button assembly 40, accidental touching may be reduced; for the charging assembly 50, damage to the charging interface and lines due to factors such as holding pressure, sweat erosion (if hands sweat), etc., may be avoided.

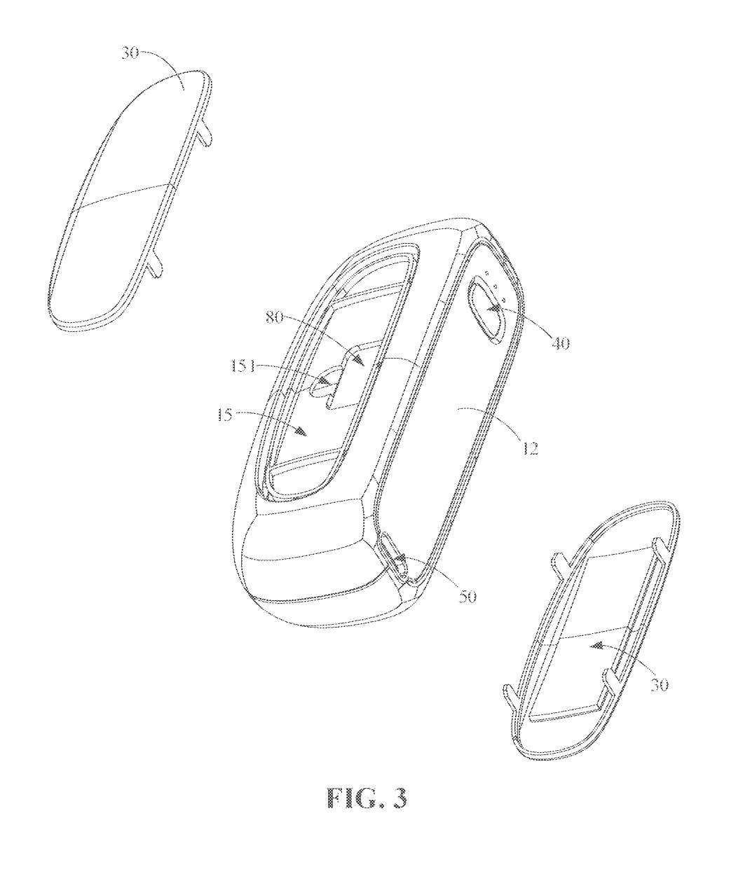

In some embodiments, referring to FIG. 3, the hand warmer unit 100 includes a heating assembly 30 disposed on the surrounding wall 11. An outer surface of the housing 10 defines an installation slot 15, and the heating assembly 30 is disposed in the installation slot 15. A bottom wall of the installation slot 15 is arranged with an installation position 151 in communication with the cavity 14. The hand warmer unit 100 further includes a temperature sensing component, and the temperature sensing component is disposed at the installation position 151.

In the embodiments, the installation slot 15 provides a dedicated placement space for the heating assembly 30, allowing the heating assembly 30 to be steadily installed on the outer surface of the housing 10, thereby effectively preventing the heating assembly 30 from displacing, damaging, or interfering with other components due to external forces such as collision or squeezing during daily use, transportation, or storage of the hand warmer 200.

The installation position 151 may be a through hole or a blind hole. The shape of the installation position 151 may be square, circular, semicircular, etc., which is not limited herein. The installation position 151 on the bottom wall of the installation slot 15 provides a position adjacent to the heating assembly 30 for the temperature sensing component, facilitating the detection of the temperature of the heating assembly 30. The communication of the installation position 151 to the cavity 14 may facilitate the electrical connection between the temperature sensing component and the circuit board 70 in the cavity 14.

Further, referring to FIG. 3, the bottom wall of the installation slot 15 further defines a wire passing hole 80, and the wire passing hole 80 connects the installation position 151 and the cavity 14.

In the embodiments, the wire passing hole 80 provides a convenient channel for internal wiring of the hand warmer unit 100. For example, the power line of the heating assembly 30, the signal line of the temperature sensing component, etc., can enter the cavity neatly through the wire passing hole 80 and connect to the corresponding circuit interfaces, thereby making the internal wiring direction of the hand warmer unit 100 clearer and more reasonable, facilitating wiring operations during production and assembly, and improving production efficiency.

In addition, the wire passing hole 80 avoids the need to reserve a large amount of extra space on structures such as the housing 10 and magnetic attraction wall 12 for wiring or using complex and circuitous wiring methods. By utilizing the relatively hidden and efficient wire channel of the wire passing hole 80, the internal components of the hand warmer unit 100 can be laid out more compactly, reducing unnecessary space waste, making the overall structure of the hand warmer unit 100 more compact, helping to achieve product miniaturization design, and facilitating user carrying and use.

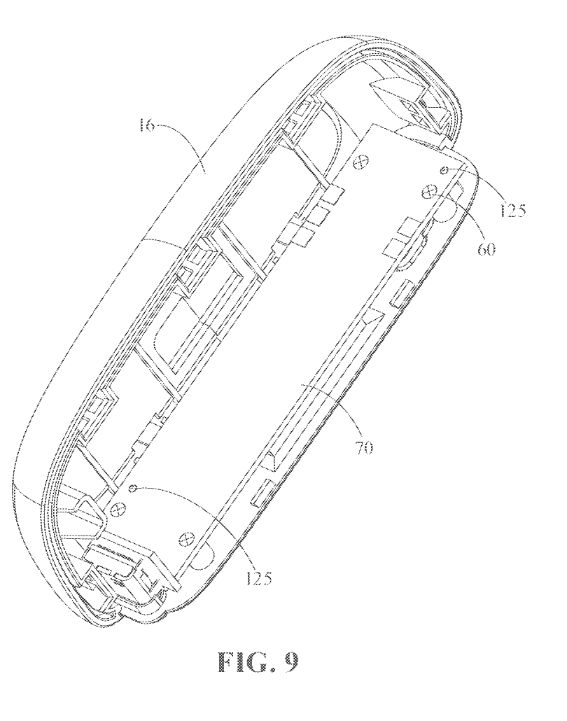

In some embodiments, referring to FIGS. 7 to 9, a side of the magnetic attraction wall 12 facing the cavity 14 is further arranged with a fixed post 124 and a positioning post 125. The hand warmer unit 100 further includes a fastener 60 and a circuit board 70. The circuit board 70 defines a first hole 71 and a second hole 72 corresponding to the fixed post 124 and positioning post 125, respectively. The positioning post 125 is inserted into the first hole 71. The fastener 60 passes through the second hole 72 and is fixedly connected to the fixed post 124.

In the embodiments, the cooperation between the positioning post 125 and the first hole 71 on the circuit board 70 may accurately position the circuit board 70 inside the hand warmer 200. The cooperation between the fixed post 124 and the fastener 60 may achieve firm fixation of the circuit board 70, thereby preventing displacement and loosening of the circuit board 70.

In some embodiments, two positioning posts 125 are arranged along the diagonal of the circuit board 70, which may achieve the fixing effect while effectively utilizing materials and reducing material waste.

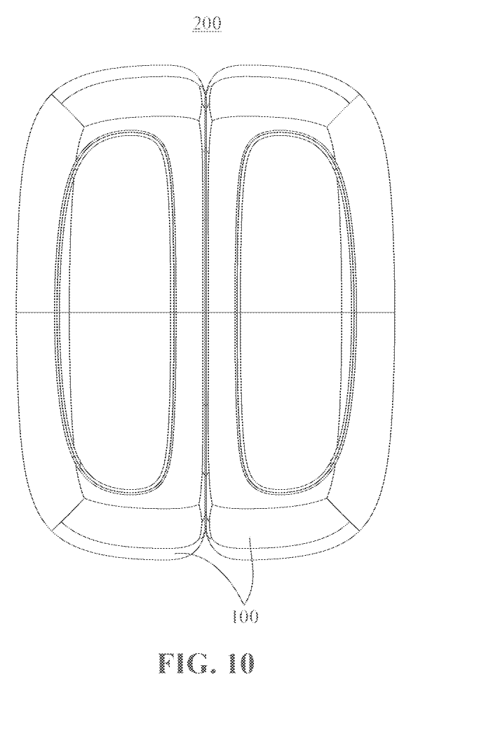

The present disclosure further proposes a hand warmer 200. Referring to FIG. 10, the hand warmer 200 includes at least two hand warmer units 100. Each hand warmer unit 100 includes a housing 10. The housing 10 includes a surrounding wall 11, a magnetic attraction wall 12, and a magnetic component 13. The surrounding wall 11 and the magnetic attraction wall 12 are connected to each other and enclose to define a cavity 14. The magnetic component 13 is disposed in the cavity 14. The magnetic attraction wall 12 includes a thin wall area 121 and a thick wall area 122 that are connected to each other. An inner side of the magnetic attraction wall 12 is thinned to form the thin wall area 121. The magnetic component 13 is attached to the thin wall area 121. The magnetic attraction walls 12 of the two hand warmer units 100 can be aligned for magnetic attraction.

In the embodiments, the magnetic component 13 being attached to the thin wall area 121 makes the magnetic attraction effect of the two hand warmer units 100 better. After the two hand warmer units 100 are combined by magnetic attraction, the warming area increases. Separate use may only warm part of the hand area, while combined use can cover a larger range, suitable for warming body parts other than the hands, such as knees or abdomen.

The magnetic attraction walls 12 of the two hand warmer units 100 may be aligned for magnetic attraction, allowing the hand warmer 200 to be used separately or in combination. For example, the two hand warmer units 100 may be separated and placed in left and right pockets for warming, or the two hand warmer units 100 may be combined and held with both hands for warming.

In addition, when the two hand warmer units 100 are not in use, they can be combined together for storage through the magnetic attraction function, thereby saving space and storing neatly, avoiding loss or damage, facilitating organization and storage, and improving storage convenience and management efficiency.

In the embodiments, the number of magnetic components 13 may be one or multiple. The number of magnetic attraction walls 12 may also be one or multiple. When the number of magnetic attraction walls 12 is one, two hand warmer units 100 can be combined for use through aligned magnetic attraction of the magnetic attraction walls 12. When the number of magnetic attraction walls 12 is multiple, multiple hand warmer units 100 can be combined for use through aligned magnetic attraction of the magnetic attraction walls 12.

Finally, it should be noted that the above embodiments are provided to illustrate the technical solutions of the present disclosure and are not intended to limit it. Although the present disclosure has been described in detail with reference to the foregoing embodiments, those skilled in the art will understand that modifications may be made to the technical solutions described in the foregoing embodiments, or equivalent replacements may be made to some of the technical features. Such modifications or replacements do not cause the corresponding technical solutions to deviate from the spirit and scope of the technical solutions of the embodiments of the present disclosure.

What is claimed is:

1. A hand warmer unit, wherein the hand warmer unit comprises a housing and a magnetic attraction component, and the housing comprises a surrounding wall and a magnetic attraction wall; the surrounding wall and the magnetic attraction wall are connected to each other and enclose to define a cavity; the magnetic attraction component is disposed in the cavity;
the magnetic attraction wall comprises a thin wall area and a thick wall area which are connected to each other; an inner side surface of the magnetic attraction wall is thinned to form the thin wall area; the magnetic attraction component is attached to the thin wall area.

2. The hand warmer unit according to claim 1, wherein the thick wall area is arranged around a periphery of the thin wall area, the magnetic attraction wall further comprises a connection area connecting the thick wall area and the thin wall area, and a thickness of the connection area gradually decreases from a side close to the thick wall area to a side close to the thin wall area.

3. The hand warmer unit according to claim 2, wherein the hand warmer unit further comprises a limiting component; the limiting component is arranged along the periphery of the thin wall area and encloses with the thin wall area to define an accommodation space, and the magnetic attraction component is disposed in the accommodation space.

4. The hand warmer unit according to claim 3, wherein the limiting component is a limiting ring; an end of the limiting ring is connected to a junction of the connection area and the thin wall area, and another end of the limiting ring extends away from the magnetic attraction wall; an end face of the limiting ring away from the thin wall area is higher than an inner side surface of the thick wall area.

5. The hand warmer unit according to claim 1, wherein the magnetic attraction wall is elongated, and the thin wall area is disposed in a middle of the magnetic attraction wall; a length of the thin wall area is one quarter of a length of the magnetic attraction wall, and a width of the thin wall area is one half of a width of the magnetic attraction wall.

6. The hand warmer unit according to claim 1, wherein the hand warmer unit further comprises two heating assemblies on the surrounding wall, and the two heating assemblies are arranged on opposite sides of the magnetic attraction wall.

7. The hand warmer unit according to claim 6, wherein the housing comprises two main body shells; the two main body shells are spliced to form the surrounding wall and enclose to define an opening; the magnetic attraction wall is connected to the two main body shells at the opening; the two heating assemblies are arranged on the two main body shells in a one-to-one correspondence.

8. The hand warmer unit according to claim 6, wherein the magnetic attraction wall is elongated; each of the two heating assemblies extends along a length direction of the magnetic attraction wall, and the two heating assemblies are arranged on both sides of the magnetic attraction wall in a width direction.

9. The hand warmer unit according to claim 1, wherein the hand warmer unit further comprises a button assembly and a charging assembly disposed on the magnetic attraction wall; the button assembly and the charging assembly are respectively arranged on both sides of the magnetic attraction component.

10. The hand warmer unit according to claim 1, wherein the hand warmer unit further comprises a heating assembly disposed on the surrounding wall; an outer surface of the housing defines an installation slot, and the heating assembly is disposed in the installation slot; a bottom wall of the installation slot is arranged with an installation position communicating with the cavity; the hand warmer unit further comprises a temperature sensing component, and the temperature sensing component is arranged at the installation position.

11. The hand warmer unit according to claim 10, wherein the bottom wall of the installation slot further defines a wire passing hole, and the wire passing hole connects the installation position and the cavity.

12. The hand warmer unit according to claim 1, wherein a side of the magnetic attraction wall facing the cavity is further arranged with a fixed post and a positioning post; the hand warmer unit further comprises a circuit board and a fastener, the circuit board defines a first hole and a second hole to match with the fixed post and the positioning post, respectively;
wherein the positioning post is inserted into the first hole, and the fastener passes through the second hole and is fixedly connected to the fixed post.

13. A hand warmer, comprising at least two hand warmer units; wherein each of the at least two hand warmer units comprises a housing and a magnetic attraction component, and the housing comprises a surrounding wall and a magnetic attraction wall; the surrounding wall and the magnetic attraction wall are connected to each other and enclose to define a cavity; the magnetic attraction component is disposed in the cavity;
the magnetic attraction wall comprises a thin wall area and a thick wall area which are connected to each other; an inner side surface of the magnetic attraction wall is thinned to form the thin wall area; the magnetic attraction component is attached to the thin wall area;
wherein the magnetic attraction walls of the at least two hand warmer units are capable of being aligned for magnetic attraction.

14. The hand warmer according to claim 13, wherein the thick wall area is arranged around a periphery of the thin wall area, the magnetic attraction wall further comprises a connection area connecting the thick wall area and the thin wall area, and a thickness of the connection area gradually decreases from a side close to the thick wall area to a side close to the thin wall area.

15. The hand warmer unit according to claim 14, wherein each of the at least two hand warmer units further comprises a limiting component; the limiting component is arranged along the periphery of the thin wall area and encloses with the thin wall area to define an accommodation space, and the magnetic attraction component is disposed in the accommodation space.

16. The hand warmer unit according to claim 15, wherein the limiting component is a limiting ring; an end of the limiting ring is connected to a junction of the connection area and the thin wall area, and another end of the limiting ring extends away from the magnetic attraction wall; an end face of the limiting ring away from the thin wall area is higher than an inner side surface of the thick wall area.

17. The hand warmer unit according to claim 13, wherein the magnetic attraction wall is elongated, and the thin wall area is disposed in a middle of the magnetic attraction wall; a length of the thin wall area is one quarter of a length of the magnetic attraction wall, and a width of the thin wall area is one half of a width of the magnetic attraction wall.

18. The hand warmer unit according to claim 13, wherein each of the at least two hand warmer units further comprises two heating assemblies on the surrounding wall, and the two heating assemblies are arranged on opposite sides of the magnetic attraction wall.

19. The hand warmer unit according to claim 13, wherein each of the at least two hand warmer units further comprises a button assembly and a charging assembly provided on the magnetic attraction wall; the button assembly and the charging assembly are respectively arranged on both sides of the magnetic attraction component.

20. The hand warmer unit according to claim 13, wherein a side of the magnetic attraction wall facing the cavity is further arranged with a fixed post and a positioning post; each of the at least two hand warmer units further comprises a circuit board and a fastener, the circuit board defines a first hole and a second hole to match with the fixed post and the positioning post, respectively;
wherein the positioning post is inserted into the first hole, and the fastener passes through the second hole and is fixedly connected to the fixed post.
